(19) United States
(12) Patent Application Publication
(10) Pub. No.: US 2025/0034733 A1
(43) Pub. Date: Jan. 30, 2025

(54) TUNING OF FORMULATIONS BASED ON ANION-CONDUCTIVE POLYMERS (IONOMERS) FOR PRODUCING ELECTROCHEMICALLY ACTIVE LAYERS

(71) Applicant: Evonik Operations GmbH, Essen (DE)

(72) Inventors: Patrick Borowski, Bottrop (DE); Artjom Maljusch, Bochum (DE); Ines Elkemann, Coesfeld (DE); Philipp Roters, Coesfeld (DE)

(21) Appl. No.: 18/711,077

(22) PCT Filed: Nov. 7, 2022
(86) PCT No.: PCT/EP2022/080984

§ 371 Date: May 16, 2024

(30) Foreign Application Priority Data
Nov. 16, 2021 (EP) 21208557.5

(51) Int. Cl. C25B 11/085; C25B 1/04; C25B 11/077

(52) U.S. Cl. CPC C25B 11/085; C25B 1/04; C25B 11/077

(57) ABSTRACT

The invention relates to the production of an electrochemically active layered body, to an electrochemically active layered body especially obtained by the production process, and to an electrochemical cell containing at least one such layered body. The invention additionally relates to a dispersion for producing the layered body. The problem addressed by the invention is that of making alternative ionomers useful for the production of electrochemically active layered bodies. The invention is based on the concept of processing an ionomer in a dispersion and using this dispersion to produce catalytically active layered bodies for electrochemical cells.

The invention relates to a dispersion which is intended for the production of an electrochemically active layer structure. The invention further relates to the production of an electrochemically active layer structure, in the context of which the inventive dispersion is provided. The invention also relates to an electrochemically active layer structure, which is obtained in particular by the production process, and also to an electrochemical cell comprising at least such a layer structure. In addition, the invention relates to a process for producing hydrogen and oxygen by cleavage of water in which the electrochemical cell is employed.

Electrochemical cells are technical devices in which electrochemical processes are carried out. They generally comprise an anode, a cathode and a separator arranged between anode and cathode which divides the electrochemical cell into two compartments. Examples of electrochemical cells are batteries, fuel cells and electrolysis cells. Electrolysis is conducted in electrolysis cells, i.e. the splitting or formation of chemical bonds with the aid of electrical energy.

An important electrolysis is water electrolysis in which water is split into oxygen and hydrogen. The separator of a water electrolysis cell may be designed as an ion-conducting membrane. A distinction is made here between anion-conducting membranes (anion exchange membranes—AEM) and proton-conducting membranes (proton exchange membranes—PEM). The cleavage of water with the aid of anion-conducting membranes is often abbreviated to AEM-WE (anion exchange membrane water electrolysis) or also called alkaline membrane water electrolysis. The well-known alkaline water electrolysis using a porous diaphragm is not an AEM-WE in today's sense since the diaphragm is fluid-conducting. The membrane of an AEM-WE is however a fluid-tight membrane. The anion conduction takes place at the level of the ions.

An excellent overview of the construction and materials of the electrochemical cells currently in use in AEM-WE is given by:
Miller, Hamish Andrew et al: Green hydrogen from anion exchange membrane water electrolysis: a review of recent developments in critical materials and operating conditions. Sustainable Energy Fuels, 2020, 4, 2114 DOI: 10.1039/c9se01240k

In electrochemical processes, conversions take place at the surface of electrocatalysts. To generate a highly catalytically active surface and to enable transport of substances, electrocatalysts are used in porous, electrically conducting layers. The layers are applied to other components of the electrochemical cell or used as a separate component. In general, the concern here are electrochemically active layer structures, regardless of whether the layer structure fulfils other functions within the cell in addition to catalysis.

In the field of water electrolysis cells it is customary to coat membranes with electrocatalytically active material such that a catalyst coated membrane (CCM) is obtained; cf. Miller et al. Sect. 5.2. A CCM of this kind is a first example of an electrochemically active layer structure.

Another example of an electrochemically active layer structure may be an electrode in which an electrically conducting substrate is coated with electrocatalytically active material so that a catalyst coated substrate (CCS) is obtained; cf. Miller et al. Sect. 5.1. A CCS of this kind is a second example of an electrochemically active layer structure.

The morphology of an electrochemically active layer structure is determined by the catalyst particles and the arrangement thereof in the layer structure. Polymeric binders are suitable for permanent mechanical adhesion of the catalyst particles to each other and to a support material—especially those that enable ion transport in accordance with the electrochemical reaction (ion-conducting polymer, often also referred to as “ionomer”).

The efficiency and service life of electrochemically active layer structures are determined in particular by the selection and coordination of the individual components and the processing thereof. Already the critical factor here is the production of suitable catalyst-ionomer formulations.

Already known in the scientific literature are some catalyst-ionomer formulations and associated processes for producing electrochemically active layer structures.

For instance, Chen et al. describe the production of CCMs for fuel cells based on the ionomer poly(fluorenyl aryl piperidinium):
Chen, N., Wang, H. H., Kim, S. P. et al. Poly(fluorenyl aryl piperidinium) membranes and ionomers for anion exchange membrane fuel cells. Nat Commun 12, 2367 (2021). DOI 10.1038/s41467-021-22612-3

Park et al. coat an anion-conducting membrane from Fumatech (FUMATECH BWT GmbH, Bietigheim-Bissingen, Germany) with a mixture of iridium oxide and platinum/carbon in order to obtain a CCM for a water electrolysis cell:
Ji Eun Park, Sun Young Kang, Seung-Hyeon Oh, et al. High-performance anion-exchange membrane water electrolysis, Electrochimica Acta, Volume 295, 2019, pages 99-106, DOI 10.1016/j.electacta. 2018.10.143

Park et al. use the polymer FAA-3-Br from Fumatech (FUMATECH BWT GmbH, Bietigheim-Bissingen, Germany) as ionomer. However, Park et al. do not provide a precise specification of the ionomer FAA-3-Br.

Leng et al. produced catalyst-coated electrodes for an alkaline fuel cell by spraying a carbon nonwoven with a Pt-containing ink. The ink comprised a precursor of a Nafion ionomer. The ionomer was first cross-linked in situ on the carbon nonwoven:
Yongjun Leng, Lizhu Wang, Michael A. Hickner, et al., Alkaline membrane fuel cells with in-situ cross-linked ionomers, Electrochimica Acta, Volume 152, 2015, pages 93-100, DOI 10.1016/j.electacta. 2014.11.055

In a similar manner, Faid et al. use a catalyst ink comprising dissolved ionomer, catalyst, isopropanol and water. The catalyst system used is Ni, Ni/C and Pt/C and Ir:
Alaa Y. Faid, et al.: Effect of anion exchange ionomer content on electrode performance in AEM water electrolysis, International Journal of Hydrogen Energy, Volume 45, Issue 53, 2020, pages 28272-28284, DOI 10.1016/j.ijhydene. 2020.07.202

US 2021/0009726 A1 discloses the production of electrochemically active layer structures. More precisely, the layer structures are MEA (Membrane Electrode Assemblies), which are intended for use in fuel cells. In the production of MEA, an ionomer is dissolved in a water/alcohol mixture and catalyst particles are dispersed in the solution. The dispersion is applied to a substrate. This procedure assumes that the ionomer is soluble in water/alcohol. Electrochemically active layer structures that are intended to be used in water electrolysis must not contain any water-soluble ionomers, since these would dissolve again during operation of the cell.

Pandiarajan T. et al coat an MEA with a dispersion of catalyst, ionomer, DMSO, 2-propanol and water. Spinel Ce-doped manganese/iron is used as catalyst.
Pandiarajan T., Berchmans L. J., Ravichandran S.: Fabrication of spinel ferrite based alkaline anion exchange membrane water electrolysers for hydrogen production. DOI: 10.1039/c5ra01123j

WO 2021/013694 A1 discloses an anion-conducting polymer with a structural formula (I), which may be used for producing membranes. The production of CCMs, CCSs and other electrochemically active layer structures is not disclosed therein.

The preparation of ionomers with a structural formula (II) is described in European application 21152487.1 that was still unpublished at the filing date of this application.

The preparation of ionomers with a structural formula (III) is described in European application 21162711.2 that was still unpublished at the filing date of this application.

The object of the invention was that of making anion-conducting polymers usable as ionomers for producing electrochemically active layer structures.

This object is achieved, respectively, by a dispersion according to Claim 1, by a process for producing an electrochemically active layer structure according to Claim 8, by the electrochemically active layer structure according to Claims 13 and 15, by the electrochemical cells according to Claim 16 and by the process for producing hydrogen and oxygen according to Claim 17. Preferred embodiments of the invention are set out in the dependent claims.

All these subject matters are based on the uniform concept of bringing an ionomer according to structural formula (I), (II) and (III) into solution, processing it in a dispersion and producing catalytically active layer structures for electrochemical cells using this dispersion. All the subject matters disclosed herein therefore form a common inventive complex.

In the course of investigations, it has been found that this type of polymer (ionomers) could be successfully processed into catalyst layers, especially in connection with the catalyst-ionomer formulations coordinated below, which are particularly suitable for electrochemical processes in which the transport of anions takes place. This functions particularly well in terms of AEM-WE processes. The layer structures produced from the dispersion described here are therefore particularly suitable for use as CCM or CCS in alkaline water electrolyses.

The common advantage of the ionomers of structural formula (I), (II) or (III) is their good ionic conductivity, high chemical and mechanical resistance in an alkaline medium, and low synthesis costs.

The anion-conducting polymers processed to dispersions conform to the structural formula (I) or (II) or (III).

The anion-conducting polymer of structural formula (I) is defined as follows:

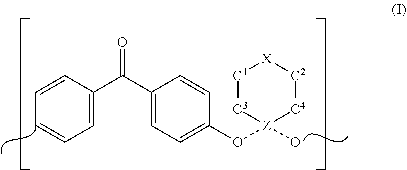

in which X is a structural element comprising a positively charged nitrogen atom bonded to C¹ and C² and which is bonded via two bonds to one or two hydrocarbon radicals comprising 1 to 12, preferably 1 to 6, particularly preferably 1 or 5 carbon atoms and in which Z is a structural element comprising a carbon atom bonded to C³ and C⁴, and which comprises at least one aromatic six-membered ring which is bonded directly to one of the oxygen atoms, wherein the aromatic six-membered rings may be substituted by one or more halogen and/or one or more C₁- to C₄-alkyl radicals.

The anion-conducting polymer of structural formula (II) is defined as follows:

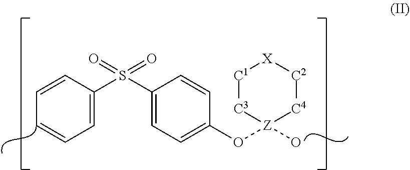

in which X is a structural element comprising a positively charged nitrogen atom bonded to C¹ and C² and which is bonded via two bonds to one or two hydrocarbon radicals comprising 1 to 12, preferably 1 to 6, particularly preferably 1 or 5 carbon atoms,
and in which Z is a structural element comprising a carbon atom bonded to C³ and C⁴, and which comprises at least one aromatic six-membered ring which is bonded directly to one of the oxygen atoms, wherein the aromatic six-membered ring may be substituted in positions 3 and 5 with the same or different C₁- to C₄-alkyl radicals, in particular with a methyl, isopropyl or tert-butyl group, the methyl group being preferred.

The anion-conducting polymer of structural formula (III) is defined as follows:

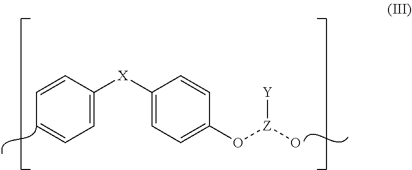

in which X is a ketone or sulfone group;
in which Z is a structural element comprising at least one tertiary carbon atom and at least one aromatic six-membered ring, where the aromatic six-membered ring is directly bonded to one of the two oxygen atoms;
in which Y is a structural element comprising at least one nitrogen atom having positive charge, where this nitrogen atom is bonded to the structural element Z.

A first subject matter of the invention is thus a dispersion comprising at least the following components:
a solution of an anion-conducting polymer;
particles comprising at least one electrocatalytically active substance;
optionally at least one dispersant;
in which the anion-conducting polymer comprises at least one structure selected from the group consisting of the structural formulae (I), (II) and (III) as defined above.

Within the dispersion, the mass ratio of anion-conducting polymer to particles is between 1:1 and 1:20 or between 1:1 and 1:5 or between 1:6 and 1:10. This means that the proportion by weight of the particles comprising the electrocatalytically active substance is greater than the proportion by weight of the anion-conducting polymer. In this manner, a high density of catalytically active centres is achieved. The layer structure produced from the dispersion thus achieves a particularly high electrochemical activity.

These ionomers can be particularly well dissolved in solvents from the following group: N-methyl-2-pyrrolidone (NMP), N,N-dimethylformamide (DMF), N,N-dimethylacetamide (DMAC) or dimethyl sulfoxide (DMSO). Preference is given to DMSO here. The solvent can be removed by drying so that the ionomer remains as a solid in the form of a polymer film. The concentration of the anion-conducting polymer, based on the volume of the solvent, should be between 10 mg/ml and 500 mg/ml or between 50 mg/ml and 100 mg/ml.

Preferably, an electrocatalytically active substance is used comprising at least one transition element. Transition elements in the context of the invention are Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg, Ac, Rf, Db, Sg, Bh, Hs, Mt, Ds, Rg. Substances comprising a transition element have in particular a higher electrocatalytic activity than substances without a transition element. In addition, the comparatively good electrical conductivity of the transition metals lowers the internal resistance of the electrochemical cell.

The electrolytic activity of the layer structure produced from the dispersion is effected by adding an electrocatalyst to the dispersion. The electrocatalyst is then immobilized in the layer structure later on by the ionomer. Examples of the electrocatalysts used are particles comprising an electrocatalytically active substance selected from the group consisting of iridium (Ir), iridium oxide (IrOx), nickel oxide (NiOx), cobalt oxide (CoOx), nickel-iron mixed oxide (NiFeOx), nickel-cobalt mixed oxide (NiCoOx), lead-ruthenium mixed oxide (PbRuOx), platinum on carbon (Pt/C). In order to achieve an effective density of the catalytically active centres in the layer structure, the ratio by mass of anion-conducting polymer to particles in the dispersion is adjusted to between 1:1 and 1:20 or between 1:1 and 1:5 or between 1:6 and 1:10.

An anion-conducting polymer is particularly preferably processed in the dispersion which is described by at least one of the following structural formulae (IVa) to (IVd):

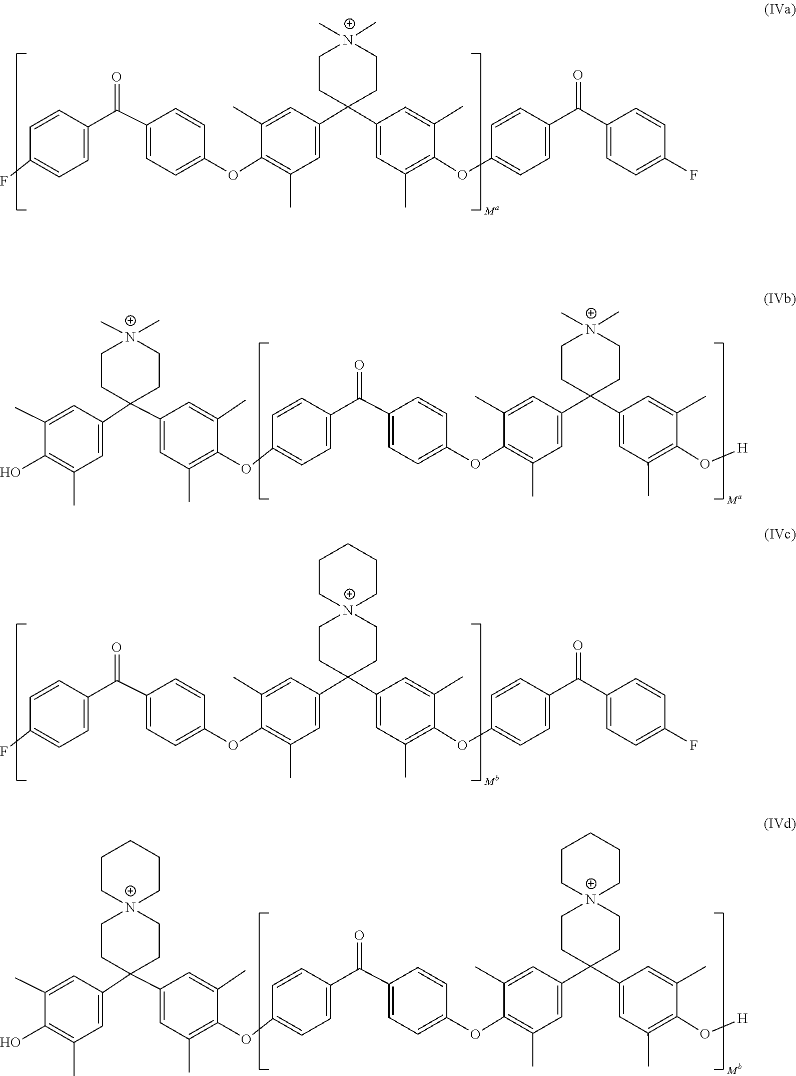

wherein M^{a} and M^{b} are a natural number from 1 to 500 or from 5 to 250, and wherein the aromatic rings may be further substituted by one or more halogens and/or by one or more C₁- to C₄-alkyl radicals, especially by methyl radicals.

The dispersion does not necessarily have to comprise a separate dispersant. Under certain circumstances, the solvent can also act as a dispersant. In order to increase the processability of the dispersion, however, at least one dispersant is preferably added. As a result, the dispersion is free-flowing. It is also possible to use a mixture of two or more dispersants. In particular, it has been found to be advantageous when the formulation of the dispersion comprises two dispersants, namely water and an alcohol, wherein the ratio by volume of the water to the alcohol is between 1:3 and 3:1. Preferably, water and alcohol are used in the ratio 1:1. Suitable alcohols are ethanol, methanol, 1-propanol or 2-propanol. Such a water/alcohol mixture evaporates readily when drying the dispersion.

In order to ensure good processability, the solids concentration of the dispersion is preferably between 5 mg/ml to 100 mg/ml or between 10 mg/ml and 25 mg/ml, based in each case on the total volume of the liquid constituents of the dispersion. The solids present in the dispersion correspond to the catalytically active particles. The ionomer in the solution is considered as a liquid.

The dispersion described here is intended to produce an electrochemically active layer structure.

The invention therefore further provides a process for producing an electrochemically active layer structure, comprising the steps of:
a) providing a dispersion according to the invention comprising at least the following components:
   a dispersant;
   an organic solvent different from the dispersant;
   a solution of an anion-conducting polymer in the organic solvent;
   particles comprising at least one electrocatalytically active substance;
b) providing a substrate;
c) applying the dispersion to the substrate;
d) drying the dispersion applied to the substrate;
e) obtaining a layer structure comprising the substrate and an at least two-phase coating applied thereto, wherein the coating comprises the anion-conducting polymer as first phase and the particles as second phase and wherein the second phase is dispersed in the first phase.

The solvent and the dispersant optionally present evaporates on drying such that it is not found in the layer structure.

The dispersion is applied to the substrate in a known manner by bar coating, by spraying or by screenprinting.

An advantage of the dispersion described here consists in that it can be used to coat textile substrates. Electrochemically active layer structures based on a textile structure have a particularly large surface area and can therefore enable high process intensity. The substrate used is therefore preferably a textile fabric. Textile fabrics are nonwovens, felts, woven or knitted fabrics. The fabrics are composed of fibres, threads or yarns. Preferably, felts or nonwovens are coated with the dispersion, which are composed of nickel fibres, carbon fibres or steel fibres. Such substrates are in fact available at low cost, electrically conducting and are stable in the alkaline medium of an AEM-WE process. They are suitable therefore as electrode in CCS construction.

A membrane composed of an anion-conducting polymer may also be coated with the dispersion described here. If an anion-conducting membrane is used as substrate, the layer structure obtained is a CCM. Preferably, the membrane used as substrate also comprises ionomers according to structure (I) or (II) or (III). Then a particularly good binding of the catalyst particles to the membrane can be achieved because the ionomers are compatible.

A dispersion optimally suited for the production of electrochemically active layer structures is prepared by the following procedure:
i) providing the dispersant;
ii) providing the organic solvent different from the dispersant;
iii) providing the anion-conducting polymer;
iv) providing the particles;
v) dissolving the anion-conducting polymer in the organic solvent such that a solution of the anion-conducting polymer is obtained:
vi) suspending the particles in the dispersant such that a suspension is obtained;
vii) adding the solution to the suspension.

This procedure results in a particularly homogeneous distribution of the electrocatalytically active particles in the anion-conducting polymer and a stable dispersion.

Mixtures of water and alcohol are particularly suitable as dispersants, since the particles can be suspended well therein and water and alcohol dry quickly after the dispersion has been applied. The boiling point of water and alcohol is in fact lower than that, for example, of DMSO (189° C.). Consequently, the use of water/alcohol as a dispersant in the production of electrochemically active layer structures enables rapid layer build-up. However, water is unsuitable as a solvent, since the anion-conducting polymers that are to be used in water electrolysis must be insoluble in water as a matter of principle. Otherwise, the water electrolysis cell would rapidly break down during operation. Since alcohols also poorly dissolve the anion-conducting polymers described here, a significantly more potent organic solvent must be used. Preferably, at least one of the following substances is used as organic solvent: N-methyl-2-pyrrolidone (NMP), N,N-dimethylformamide (DMF), N,N-dimethylacetamide (DMAC) or dimethylsulphoxide (DMSO). Preference is given to DMSO. These solvents can also be removed by drying, leaving the ionomer as a solid in the form of a polymer film. However, the organic substances specified are not suitable as dispersants for all catalyst systems, as sedimentation experiments show. Depending on the catalyst system selected, it therefore makes sense to use different substances as solvents or dispersants.

The invention further relates to an electrochemically active layer structure comprising a substrate and an at least two-phase coating applied thereto, wherein the coating comprises an anion-conducting polymer as first phase and particles comprising an electrocatalytically active substance as second phase, and wherein the second phase is dispersed in the first phase, wherein the anion-conducting polymer comprises at least one structure according to formula (I), (II) or (III). Depending on the substrate chosen, the layer structure particularly is a CCM or a CCS. In both cases, the loading in relation to the electrochemically active substance is preferably between 0.2 mg/cm² and 10 mg/cm² or 0.4 mg/cm² and 2 mg/cm².

The electrochemically active layer structure particularly preferably comprises an anion-conducting polymer which is described by at least one of the following structural formulae (IVa) to (IVd):

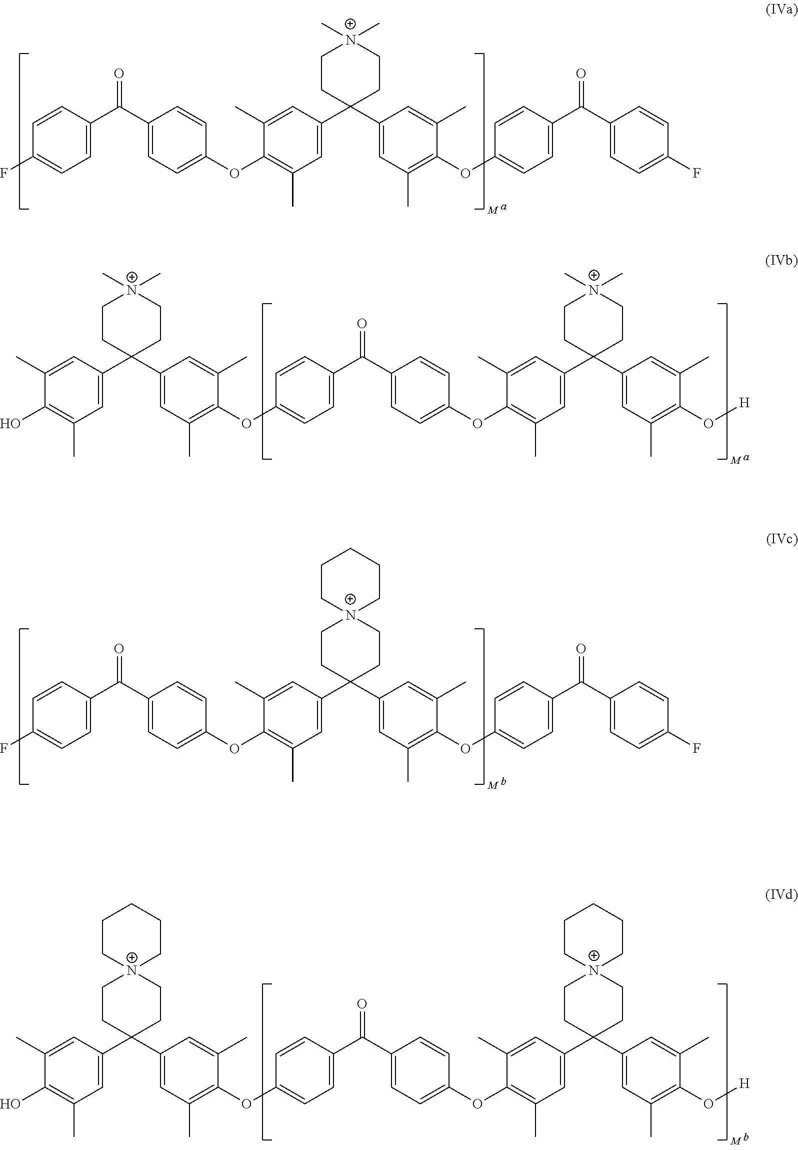

wherein M^{a} and M^{b} are a natural number from 1 to 500, preferably from 5 to 250 and wherein the aromatic rings may be further substituted by one or more halogens and/or by one or more C₁- to C₄-alkyl radicals, especially by methyl radicals.

Such ionomers have good ionic conductivity, high chemical and mechanical resistance in the alkaline medium and have low synthesis costs. They also immobilize the catalyst particles well on the substrate and can be processed outstandingly well in the dispersion.

Depending on the selected formulation of the dispersion, the chosen application method and the time/temperature regime of the drying process, the coating on the substrate, or more precisely its first disperse phase of the anion-conducting polymer, acquires a specific structure that improves the accessibility of the catalytically active centres of the particles in the coating to the electrolytes. An electrochemically active layer structure, which is obtained by the coating process according to the invention, is therefore also a subject matter of the invention.

The electrochemically active layer structure produced from the dispersion can be used ideally in an electrochemical cell, for example as a CCM or CCS. The electrochemical cell may also comprise further components in addition to the layer structure, for example other electrodes or separators, or fluid conductors or contact plates.

Due to the particular stability of the ionomer and the catalytic activity of the particles that have been processed in the dispersion and which are found again in the layer structure, the electrochemical cell containing the layer structure is preferably used to carry out a process for the production of hydrogen and oxygen by electrochemical splitting of water, in which an aqueous electrolyte having a pH of 7 to 15 is filled into the electrochemical cell. Such an AEM-WE process is also a subject matter of the invention.

The invention is now to be elucidated in detail by working examples. The figures show:

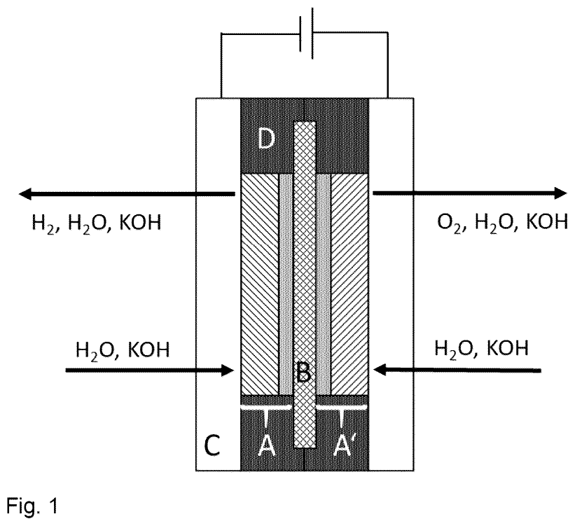

FIG. 1: Construction of the electrochemical cell

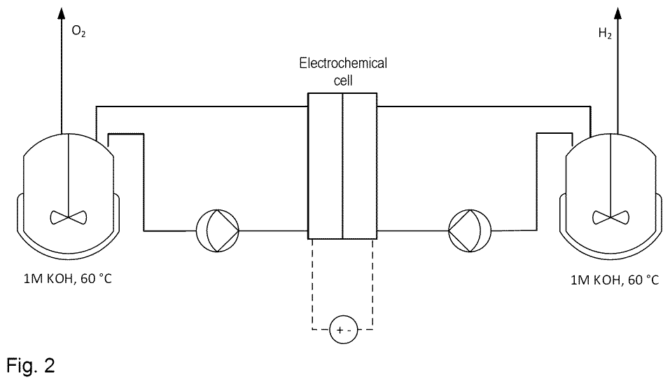

FIG. 2: Test rig for the electrochemical cell

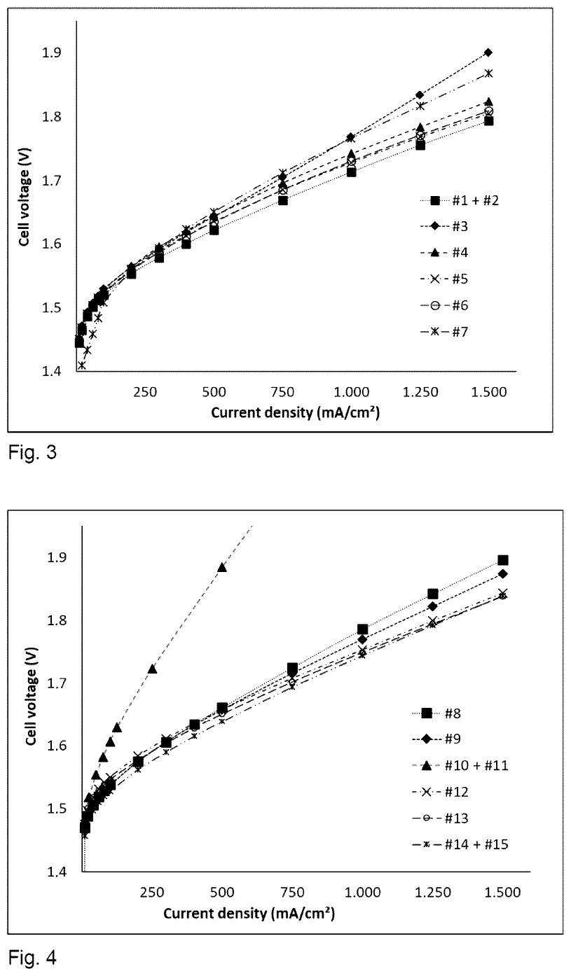

FIG. 3: Graphical depiction of the current-voltage curves.

The basis of the production of formulations with polymers described above (ionomers) is the production of an ionomer solution. Examples of suitable solvents are N-methyl-2-pyrrolidone (NMP), N,N-dimethylformamide (DMF), N,N-dimethylacetamide (DMAC) or dimethyl sulfoxide (DMSO), preference being given to DMSO since it is classified as a non-hazardous material. The proportion of the polymer is between 10 mg/ml and 500 mg/ml or between 25 mg/ml and 200 mg/ml.

The ratio by mass of ionomer to catalytically active substance is between 1:1 and 1:20 or between 1:3 and 1:5 in the case of catalysts based on, for example, platinum supported on carbon (Pt/C), iridium (Ir), iridium oxide (IrOx), nickel oxide (NiOx), cobalt oxide (CoOx), nickel-iron mixed oxide (NiFeOx), nickel-cobalt mixed oxide (NiCoOx) or lead-ruthenium mixed oxide (PbRuOx).

Catalyst and ionomer solution may firstly be applied directly (for example by means of screenprinting or a knife-coating method) after dispersing (for example with an ULTRA-TURRAX® dispersing system from IKA, Staufen, DE or a three-roll mill, for example from EXAKT, Norderstedt, DE—under the action of shear, both result in the adjustment of particle size (d₅₀ in the range between 0.1 μm and 50 μm) and dispersion). Secondly, especially for application by spraying processes, it is possible to produce aqueous dispersions in which a catalyst is first dispersed in a solution of water and lower alcohols (preferably ethanol, 1-propanol or 2-propanol) under the action of ultrasound or a disperser (for example with an ULTRA-TURRAX® dispersing system from IKA, Staufen, DE with additional adjustment of the particle size: d₅₀ in the range between 0.1 μm and 50 μm), and to which the ionomer solution (preferably 50 mg/ml) is subsequently added with subsequent further dispersion under ultrasound. The solids concentration here is between 5 mg/ml and 100 mg/ml, preferably between 10 mg/ml and 25 mg/ml. The unit mg/ml of the ionomer solution is based on the mass of polymer/volume of solvent or of the dispersion to mass of catalyst/volume of liquid constituents.

Particularly suitable substrates for the application of the formulations produced are nonwovens made of carbon or nonwovens made of metal (nickel, stainless steel, titanium) and also ion-conducting, polymeric membranes.

The loading of the substrate in relation to the catalyst is between 0.2 mg/cm² and 10 mg/cm² or 0.4 mg/cm² and 2 mg/cm².

Table 1 shows the composition of some dispersions according to the invention with which catalyst layers could be applied to substrates.

The ionomer used is a substance produced as described in example 3 of WO 2021/013694 A1.

The ionomer was initially dissolved in dimethyl sulfoxide with stirring and temperature (60° C.) for 16 h. Subsequently, the catalysts were dispersed in the dispersant, consisting of equal parts by volume of water and ethanol, either using ultrasound (BRANSONIC™ B-1200 E2 from Branson Ultrasonics Corporation, Brookfield, CT, US) for 30 min in an ice-bath and at 30 W power or using an ULTRA-TURRAX® T10 basic dispersing system (IKA, Staufen, DE) for 3 min at stage 3. After adding the ionomer solution, further dispersion is effected using ultrasound in an ice-bath for 1 min at a 30 W power setting and dispersion using a shaker (MS1 Minishaker from IKA, Staufen, DE) for 10 s at 2500 rpm. The proportions were selected corresponding to Table 1.

The dispersions according to the invention were sprayed onto the substrates using a PRISM 400 (Ultrasonic Systems, Inc, Haverhill, MA, US) ultrasound spray coater. The formulation is stirred continuously during the process. These substrates were kept at a temperature of 60° C., whereby the dispersant evaporated continuously so that the layer structures according to the invention were produced.

The layer structures thus obtained could be used as electrodes for generating hydrogen and/or oxygen in the alkaline membrane water electrolysis (AEM-WE). The electrochemical cell according to FIG. 1 consisted essentially of two electrically active layer structures (A, A′) (at least one of which was produced by the process according to the invention), which were separated by an anion-conducting membrane (B). The electrolyte supply (1 M KOH, 60° C.) was provided via a flow and current distributor (C), which were electrically isolated via seals (D).

The function of the layer structures produced could be demonstrated in the aforementioned cell in a test rig (FIG. 2) using typical current-voltage curves (galvanostatic: 0.02-1.50 A/cm²), which the diagrams in FIG. 3 and FIG. 4 show.

In principle, the catalyst layers produced on the basis of the catalyst-ionomer formulations (dispersions) described can also be used in electrochemical processes other than alkaline membrane water electrolysis (AEM-WE)—examples of this are an alkaline fuel cell or the electrolysis (reduction) of carbon dioxide.

TABLE 1
Composition of dispersions

| | Ionomer | | | | | | | | | Electro- |
|---|---|---|---|---|---|---|---|---|---|---|
| | solution | | | | | | | | | chemically |
| | Concen- | | | | | Catalyt- | | | | active |
| | tration | | | Dispersant | | ically | Solids | | | substance |
| Exam- | of Ionomer | Mass ratio | | Propor- | Propor- | active | content | | | on substrate |
| ple | in DMSO | Parti- | Iono- | tion of | tion of | substance | Concentration | Dispersion | Substrate | Loading |
| # | [mg/ml] | cle | mer | water | ethanol | Designation | [mg/ml] | Technology | Designation | [mg/cm²] |
| 1 | 50 | 3 | 1 | 1 | 1 | Pt/C | 11 | Ultrasound | Nonwoven: carbon | 0.6 |
| 2 | 50 | 4 | 1 | 1 | 1 | Ir | 11 | Ultrasound | Nonwoven: | 1.0 |
| | | | | | | | | | Stainless steel | |
| 3 | 50 | 4 | 1 | 1 | 1 | IrOx | 11 | Ultrasound | Nonwoven: carbon | 1.1 |
| 4 | 50 | 3 | 1 | 1 | 1 | Ir | 11 | Ultrasound | Nonwoven: | 0.9 |
| | | | | | | | | | Stainless steel | |
| 5 | 50 | 6 | 1 | 1 | 1 | Ir | 11 | Ultrasound | Nonwoven: | 1.0 |
| | | | | | | | | | Stainless steel | |
| 6 | 50 | 9 | 1 | 1 | 1 | Ir | 11 | Ultrasound | Nonwoven: | 1.0 |
| | | | | | | | | | Stainless steel | |
| 7 | 50 | 4 | 1 | 1 | 1 | PbRuOx | 11 | Ultrasound | Nonwoven: | 1.0 |
| | | | | | | | | | Stainless steel | |
| 8 | 50 | 4 | 1 | 1 | 1 | NiOx | 11 | Ultrasound | Nonwoven: | 0.9 |
| | | | | | | | | | Stainless steel | |
| 9 | 50 | 4 | 1 | 1 | 1 | CoOx | 11 | Ultrasound | Nonwoven: | 0.9 |
| | | | | | | | | | Stainless steel | |
| 10 | 27.5 | 13 | 1 | 1 | 1 | Pt/C | 27 | Ultrasound | Nonwoven: carbon | 0.2 |
| 11 | 27.5 | 13 | 1 | 1 | 1 | IrOx | 27 | Ultrasound | Nonwoven: carbon | 1.6 |
| 12 | 50 | 3 | 1 | 1 | 1 | Pt/C | 11 | Ultrasound | Membrane | 0.6 |
| 13 | 50 | 4 | 1 | 1 | 1 | Ir | 11 | Ultrasound | Membrane | 1.0 |
| 14 | 50 | 3 | 1 | 1 | 1 | Pt/C | 11 | ULTRA-TURRAX ® | Nonwoven: carbon | 0.7 |
| 15 | 50 | 4 | 1 | 1 | 1 | Ir | 11 | ULTRA-TURRAX ® | Nonwoven: | 1.0 |
| | | | | | | | | | Stainless steel | |

### Sedimentation Experiments

The stability of the dispersions should be investigated by sedimentation experiments. Four different compositions are available for this, each considered with and without ionomer. Either platinum/carbon or nickel oxide is used as catalyst.

### Procedure:

The dispersions are prepared in a vial with snap-on caps:
Dispersion 1: 11 mg/ml Pt/C in DMSO
Dispersion 2: 11 mg/ml Pt/C in ethanol:water
Dispersion 3: 11 mg/ml NiO in DMSO
Dispersion 4: 11 mg/ml NiO in ethanol:water

Dispersions 1 to 4 are placed in the ultrasound bath for 30 minutes and then shaken. The sedimentation is observed and documented.

Ionomer is added after about 30 minutes:
Dispersion 1 and 2: +3.7 mg/ml ionomer
Dispersion 3 and 4: +2.8 mg/ml ionomer

The dispersions are placed in the ultrasound bath for one minute, shaken and the sedimentation observed.

### Observations:

A dispersion of Pt/C in DMSO+ionomer sediments after 15 minutes and forms two phases, the upper phase being transparent and the lower phase black. The dispersions of nickel oxide in ethanol and water, with and without ionomer, also separate into two phases. Without ionomer, this develops after ca. 3 minutes. Here, a black layer settles at the bottom and a dark grey layer above. In the dispersion with ionomer, a slight separation into light and dark layers can also be seen after 3 minutes, but this becomes more visible after 15 minutes. The upper phase is milky and the lower phase black.

The Pt/C dispersions in ethanol and water with and without ionomer, and also nickel oxide in DMSO with and without ionomer and Pt/C in DMSO do not exhibit any abnormalities during the test period.

1. A dispersion comprising at least the following components:
a solution of an anion-conducting polymer;
particles comprising at least one electrocatalytically active substance;
optionally at least one dispersant;
wherein the anion-conducting polymer comprises at least one structure selected from the group consisting of the structural formulae (I), (II) and (III): 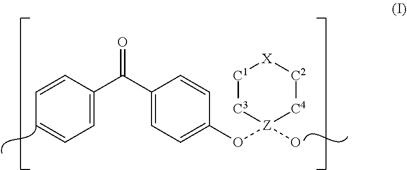
wherein, in (I), X is a structural element comprising a positively charged nitrogen atom bonded to C¹ and C² and which is bonded via two bonds to one or two hydrocarbon radicals comprising 1 to 12, preferably 1 to 6, particularly preferably 1 or 5 carbon atoms
and wherein, in (I), Z is a structural element comprising a carbon atom bonded to C³ and C⁴, and which comprises at least one aromatic six-membered ring which is bonded directly to one of the oxygen atoms, wherein the aromatic six-membered rings may be substituted by one or more halogen and/or one or more C₁- to C₄-alkyl radicals; 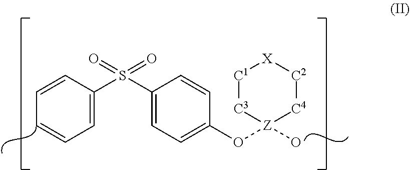
wherein, in (II), X is a structural element comprising a positively charged nitrogen atom bonded to C¹ and C² and which is bonded via two bonds to one or two hydrocarbon radicals comprising 1 to 12, preferably 1 to 6, particularly preferably 1 or 5 carbon atoms,
and wherein, in (II), Z is a structural element comprising a carbon atom bonded to C³ and C⁴, and which comprises at least one aromatic six-membered ring which is bonded directly to one of the oxygen atoms, wherein the aromatic six-membered ring may be substituted in positions 3 and 5 with the same or different C₁- to C₄-alkyl radicals, in particular with a methyl, isopropyl or tert-butyl group, the methyl group being preferred; 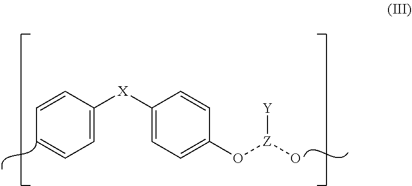
wherein, in (III), X is a ketone or sulfone group;
wherein, in (III), Z is a structural element comprising at least one tertiary carbon atom and at least one aromatic six-membered ring, where the aromatic six-membered ring is bonded directly to one of the two oxygen atoms;
and wherein, in (III), Y is a structural element comprising at least one nitrogen atom having positive charge, wherein this nitrogen atom is bonded to the structural element Z;
wherein
the ratio by mass of anion-conducting polymer to particles in the dispersion is between 1:1 and 1:20 or between 1:1 and 1:5 or between 1:6 and 1:10.

2. The dispersion according to claim 1, wherein the solution of the anion-conducting polymer comprises at least one solvent selected from the group consisting of N-methyl-2-pyrrolidone (NMP), N,N-dimethylformamide (DMF), N,N-dimethylacetamide (DMAC) or dimethyl sulfoxide (DMSO), and that the concentration of the anion-conducting polymer, based on the volume of the solvent, is between 10 mg/ml and 500 mg/ml or between 50 mg/ml and 100 mg/ml.

3. The dispersion according to claim 1, wherein the electrocatalytically active substance comprises at least one transition element.

4. The dispersion according to claim 1, wherein the particles comprise at least one electrocatalytically active substance selected from the group consisting of iridium (Ir), iridium oxide (IrOx), nickel oxide (NiOx), cobalt oxide (CoOx), nickel-iron mixed oxide (NiFeOx), nickel-cobalt mixed oxide (NiCoOx), lead-ruthenium mixed oxide (PbRuOx), platinum on carbon (Pt/C) and that the ratio by mass of anion-conducting polymer to particles in the dispersion is between 1:1 and 1:20 or between 1:1 and 1:5 or between 1:6 and 1:10.

5. The dispersion according to claim 4, wherein the anion-conducting polymer is described by at least one of the following structural formulae (IVa) to (IVd): 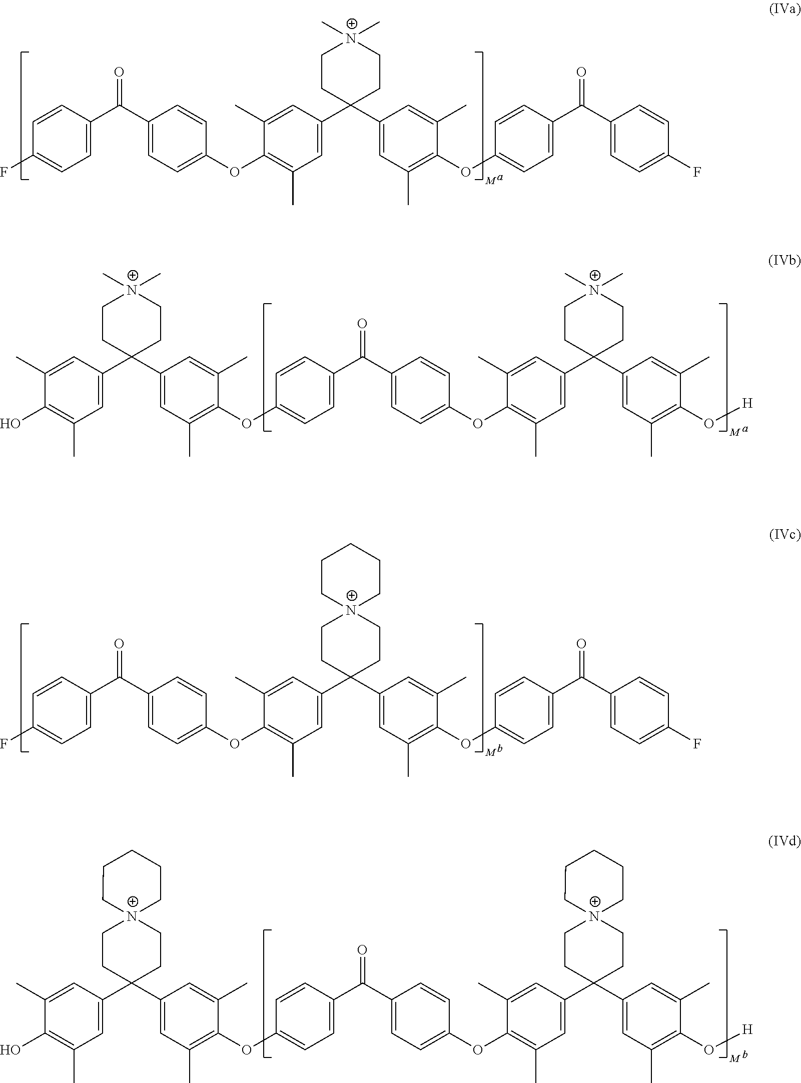
wherein M^{a} and M^{b} are a natural number from 1 to 500 or from 5 to 250, and wherein the aromatic rings may be further substituted by one or more halogens and/or by one or more C₁- to C₄-alkyl radicals, especially by methyl radicals.

6. The dispersion according to claim 5 comprising two dispersants, namely water and an alcohol, wherein the ratio by volume of the water to the alcohol is between 1:3 and 3:1.

7. The dispersion according to claim 2, wherein a solids concentration of 5 mg/ml to 100 mg/ml or between 10 mg/ml and 25 mg/ml, based in each case on the total volume of the liquid constituents of the dispersion.

8. A process for producing an electrochemically active layer structure, comprising the following steps:
a) providing a dispersion according to claim 1 comprising at least the following components:
a dispersant;
an organic solvent different from the dispersant;
a solution of an anion-conducting polymer in the organic solvent;
particles comprising at least one electrocatalytically active substance;
b) providing a substrate;
c) applying the dispersion to the substrate;
d) drying the dispersion applied to the substrate;
e) obtaining a layer structure comprising the substrate and an at least two-phase coating applied thereto, wherein the coating comprises the anion-conducting polymer as first phase and the particles as second phase and wherein the second phase is dispersed in the first phase.

9. The process according to claim 8, wherein the application is carried out by bar coating, by spraying or by screenprinting.

10. The process according to claim 8, wherein the substrate is a textile fabric composed of fibres of nickel, carbon or steel.

11. The process according to claim 8, wherein the substrate is a membrane composed of an anion-conducting polymer.

12. The process according to claim 8, wherein the dispersion is provided as follows:
i) providing the dispersant;
ii) providing the organic solvent different from the dispersant;
iii) providing the anion-conducting polymer;
iv) providing the particles;
v) dissolving the anion-conducting polymer in the organic solvent such that a solution of the anion-conducting polymer is obtained:
vi) suspending the particles in the dispersant such that a suspension is obtained;
vii) adding the solution to the suspension.

13. An electrochemically active layer structure comprising a substrate and an at least two-phase coating applied thereto, wherein the coating comprises an anion-conducting polymer as first phase and particles comprising an electrocatalytically active substance as second phase, and wherein the second phase is dispersed in the first phase,
wherein
the anion-conducting polymer comprises at least one structure selected from the group consisting of the structural formulae (I), (II) and (III): 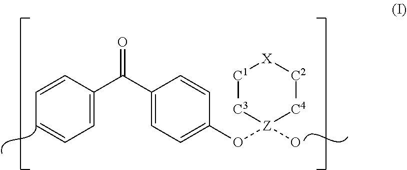
wherein, in (I), X is a structural element comprising a positively charged nitrogen atom bonded to C¹ and C² and which is bonded via two bonds to one or two hydrocarbon radicals comprising 1 to 12, preferably 1 to 6, particularly preferably 1 or 5 carbon atoms
and wherein, in (I), Z is a structural element comprising a carbon atom bonded to C³ and C⁴, and which comprises at least one aromatic six-membered ring which is bonded directly to one of the oxygen atoms, wherein the aromatic six-membered rings may be substituted by one or more halogen and/or one or more C₁- to C₄-alkyl radicals; 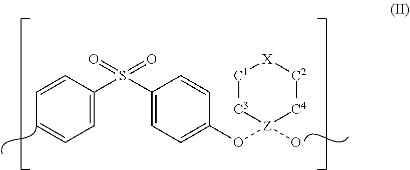
wherein, in (II), X is a structural element comprising a positively charged nitrogen atom bonded to C¹ and C² and which is bonded via two bonds to one or two hydrocarbon radicals comprising 1 to 12, preferably 1 to 6, particularly preferably 1 or 5 carbon atoms,
and wherein, in (II), Z is a structural element comprising a carbon atom bonded to C³ and C⁴, and which comprises at least one aromatic six-membered ring which is bonded directly to one of the oxygen atoms, wherein the aromatic six-membered ring may be substituted in positions 3 and 5 with the same or different C₁- to C₄-alkyl radicals, in particular with a methyl, isopropyl or tert-butyl group, the methyl group being preferred; 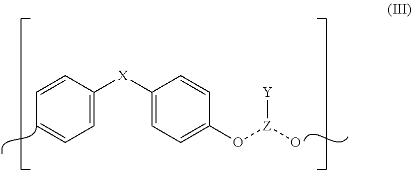
wherein, in (III), X is a ketone or sulfone group;
wherein, in (III), Z is a structural element comprising at least one tertiary carbon atom and at least one aromatic six-membered ring, where the aromatic six-membered ring is bonded directly to one of the two oxygen atoms;
and wherein, in (III), Y is a structural element comprising at least one nitrogen atom having positive charge, wherein this nitrogen atom is bonded to the structural element Z.

14. The electrochemically active layer structure according to claim 13, wherein the anion-conducting polymer is described by at least one of the following structural formulae (IVa) to (IVd): 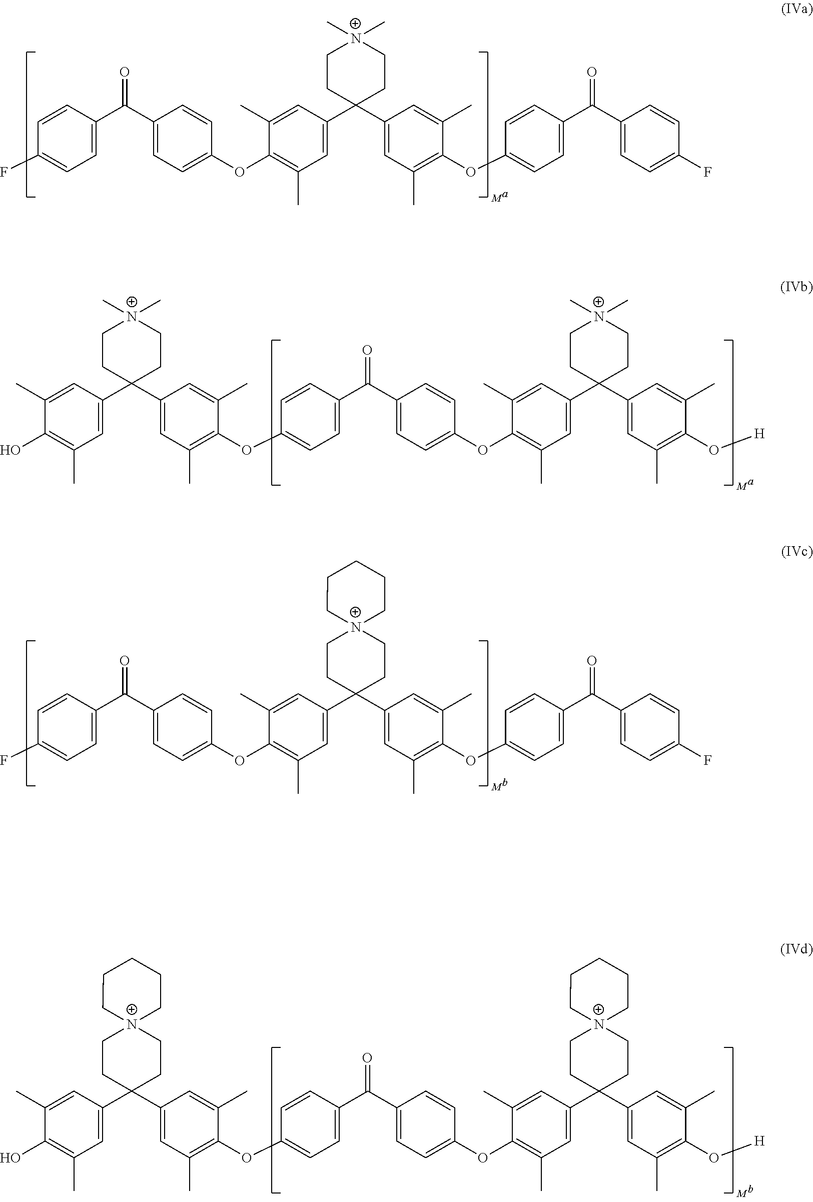
wherein M^{a} and M^{b} are a natural number from 1 to 500, preferably from 5 to 250, and wherein the aromatic rings may be further substituted by one or more halogens and/or by one or more C₁- to C₄-alkyl radicals, especially by methyl radicals.

15. (canceled)

16. The electrochemical cell comprising at least one electrochemically active layer structure according to claim 13.

17. The process for producing hydrogen and oxygen by electrochemical cleavage of water, in which an aqueous electrolyte having a pH of 7 to 15 is filled into an electrochemical cell according to claim 16.
